(19) United States
(12) Patent Application Publication
(10) Pub. No.: US 2011/0221242 A1
(43) Pub. Date: Sep. 15, 2011

(54) AIR CONDITIONING DEVICE FOR SEATS

(75) Inventor: Dragan Juric, Odelzhausen (DE)

(73) Assignee: W.E.T. AUTOMOTIVE SYSTEMS AG, Odelzhausen (DE)

(21) Appl. No.: 12/740,038

(22) PCT Filed: Oct. 29, 2008
(86) PCT No.: PCT/DE08/01754

§ 371 Date: Apr. 27, 2010

(30) Foreign Application Priority Data
Oct. 29, 2007 (DE) 10 2007 051 937.2

(51) Int. Cl. A47C 7/02; A47C 7/62; F16L 3/00

(52) U.S. Cl. 297/180.1; 137/899

(57) ABSTRACT

The present invention concerns a climate control arrangement for an interior appointment object of a vehicle with at least one air delivery device and at least one air distributing device. It is provided that the air distributing device has at least two flow branches.

### CLAIM OF PRIORITY

The present application claims priority from the 29 Oct. 2008 filed PCT Application PCT/DE2008/001754, which claims priority from German Application No. DE 102007051937.2, filed on 29 Oct. 2007, respectively, disclosure of which is hereby incorporated by reference herein.

### BACKGROUND OF THE INVENTION

The object of the present invention is a seat and a climate control arrangement.

### PRIOR ART

Vehicle seats or other seat furnishings often have regions of a sitting or backrest surface separated from each other by tackings.

In the case of climatized vehicle seats or other seat furniture with air conducting layers in the region of sitting and/or backrest contact surfaces, the problem often arises with back-stitched seat covers that the regions of a sitting or backrest surface that are separated by tackings are only unevenly climatized because there is an inadequate flow connection across the upholstery tacking channels.

Also the producing of 90° angles and smooth cushion edges is often difficult with known spacer media, so that channels or upholstery edges formed by spacer media often do not have a clean appearance. A generally practiced technique is to place spacer knitting only in seat areas free of channels and to ventilate surfaces of the sitting region that are separated from each other by tackings separately from each other, e.g., by mini-fans, such as those of DE 10037065.

But if air-conducting layers are still arched over, e.g., by pointlike anchoring, this often diminishes the ventilating capacity, leads to a less visually attractive appearance, since the depth of the channel is changed, and/or reduces the lifetime of electrical components (such as seat heating) situated close to the surface, due to increased load.

From WO 2004/100828 A2 a climatized seat is known with several interconnected tubes for distributing air in a seat. But neither does this show a solution for rather deep tackings.

It is expected that climatized seats will be economical in price, simple to install, and visually unobjectionable, and that they will not impair the comfort of the seat cushion during operation.

This aim of the invention is achieved with the subject of claim 1. Features of other advantageous embodiments of the invention result from the dependent claims and the following description.

### FIGURES

Details of the invention will be discussed in the following. These embodiments should make the invention clear. However, they are only examples. Of course, one or more of the described features can also be omitted, modified, or supplemented in the context of the invention. And the features of different embodiments can also be combined with each other, of course. The decisive point is that the concept of the invention is essentially implemented. If a feature is to be at least partly fulfilled, this includes the case when this feature is also entirely fulfilled or essentially entirely fulfilled. “Essentially” means in particular that the implementation enables an achievement of the desired usage in a recognizable extent. This can mean, in particular, that a corresponding feature is fulfilled by at least 50%, 90%, 95% or 99%. If a minimum amount is indicated, then of course more than this minimum amount can also be used. Unless otherwise indicated, ranges include their terminal points.

Hereinafter, reference is made to:

FIG. 1 Motor vehicle and seat in partial lengthwise section

FIG. 2a Perspective view of a seat of FIG. 1 partly cut open

FIG. 2b Second variant of a seat likewise partly cut open

FIG. 3 Schematic view of a climate control arrangement for seats per FIGS. 2a and 2b

FIG. 4 Cross section through an air conduction device of a climatization arrangement of FIG. 3.

### DESCRIPTION OF THE INVENTION

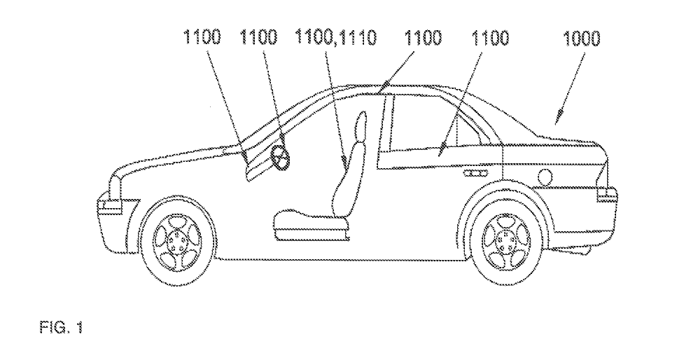

FIG. 1 shows a vehicle 1000. This can be, for example, an airplane, a railway vehicle, a ship or, as here, a motor vehicle.

The vehicle 1000 has at least one interior appointment object 1100. In case of doubt, this comprehends all structural parts with which a user of the passenger compartment can come into contact, such as a steering mechanism for motor vehicles, a dashboard, an arm rest, a door paneling, a seat cushion or, as here, a seat 1110.

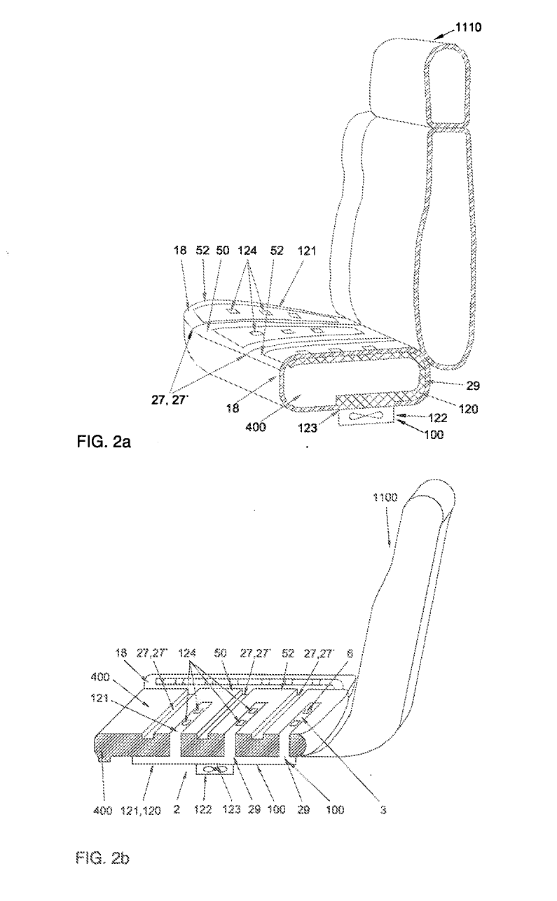

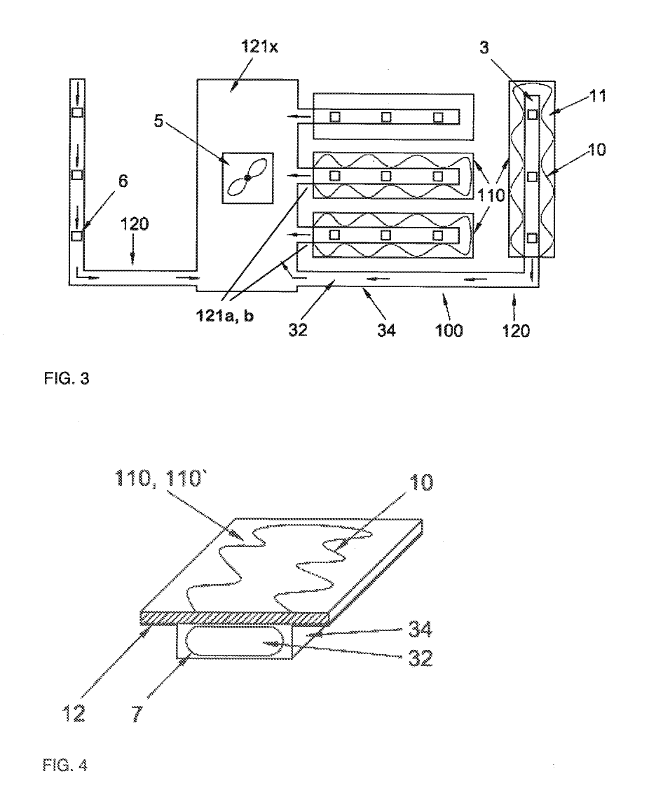

The interior appointment object 1100 has, per FIG. 2a and b, preferably at least one cushion 400 and/or at least one cover 18.

The interior appointment object 1100 often has at least one recess 27. This is provided as a spacing channel 27′, which separates two ventilated or climate-controlled zones 50 and 52 of the cushion 400 from each other. The spacing channel 27′ is at least partly covered by a cover 18, which is drawn down into the spacing channel 27′ by a spacing device.

The interior appointment object 1100 preferably has at least one climate control arrangement 100. This serves, e.g., for temperature/climate control of surfaces in contact with the user in the passenger compartment of a vehicle. It has at least one temperature control device 110, at least one air conduction device 120 and/or at least one humidity regulating device. By temperature control device is meant any device that can be used for deliberate changing of the temperature in its surroundings, such as all devices which have at least one electrical heating resistor, a heat pump, a Peltier element and/or an air movement mechanism, e.g., a fan, or those which are essentially formed therefrom. By air conduction device is meant any device that can be used for the deliberate changing of the air composition or the air flow volumes in a particular surface or spatial region for air exchange, such as a vehicle's climate control system, at least partly air-permeable spacer media, spacer knittings and/or climate control inserts. By humidity regulating device is meant a device which serves to regulate the humidity of the air in its surroundings, especially the aforementioned temperature control devices, moisture absorbers such as activated charcoal fibers or polymer superabsorbers.

The temperature control device 110 is preferably contained in the cushion 400. This allows one to reduce the distance from the user and, thus, the mass not needing temperature control. The temperature control device 110 is at least partly, preferably entirely arranged inside or on the air conduction device 120. It is preferably connected to the air conduction device 120 as a removable component.

An air conduction device 120 has at least one air inlet 123. Here, an air delivery device 122 is provided. In the present sample embodiment, this is formed by an axial fan.

Moreover, on the air conduction device 120 is provided at least one temperature control device 110. This is designed here as a sheetlike textile heating element. The temperature control device 110 is preferably arranged as close as possible to an upholstery cover 18.

The air conduction device 120 has at least one air distributing device 121, in order to distribute air along or across the sitting surface. It is preferably arranged at least partly under the cushion 400 (B-side), near the surface below the cover 18 (A-side) or some other surface of an interior appointment object 1100 as close as possible to a passenger. It extends preferably at least across those surface regions of an interior appointment object 1100 that are or can be touched by a passenger. In this way, an optimal distribution of temperature controlled air is made possible. The air distributing device 121 can be provided, e.g., as a spacer knitting, a consecutive arrangement of spirals 7, or a plurality of recesses or channels in the cushion 400.

The air conduction device 120 preferably has at least one air outlet 124, 6. Through this, temperature controlled air can preferably exit from the air conduction device 120 once again. This enables a better temperature control, since air flows brought from the air delivery device 122 into the air conduction device 120 can also actually flow at least for the most part through the air distributing device 121. The air delivery device 122 can have, for example, a plurality of air outlets 124 on the side of the interior appointment object 1100 turned toward the passenger. In this way, the temperature controlled air can be taken by the shortest path directly to the passenger. The air delivery device 122 is preferably contained in the cushion 400. In this way, the distance from the air distributing device 121 and, thus, the flow resistance can be reduced.

The described climate control arrangement 100 can be built, for example, into the seat base, sitting surface, a backrest, or a steering wheel.

The air conduction device 120 and/or at least one flow areas (121a, b) has, preferably in its interior, at least one air-permeable channel 32. This is covered at least in part by a more or less airtight wall 34.

Preferably, at least parts of the wall 34 and at least parts of the channel 32 are of variable length. In order to make possible such a change in length, it may be expedient for at least parts of the wall 34 to have components of a stretchable material, such as rubber, helical springs, knitting, etc. One can also provide that at least segments of the wall 34 can be folded or bent upon each other, in the manner of an accordion and/or an antenna. The channel 32 is preferably free of components or filling, at least for a segment, in order to minimize flow losses in the channel and resistance to a changing of the length of the walls. Preferably, however, its walls are buttressed in order to keep its flow cross section open. Fiberglass spirals and/or spacer knittings in particular can be considered as the buttressing material 7.

If the wall 34 is joined together from several parts, this will be done preferably by sewing. However, any other joining methods can also be chosen.

The air conduction device 120 is preferably designed as flat tubes with textile walls and several spirals arranged alongside each other inside them. By spirals is also meant here curves that run about a central point or axis an increasingly get closer or farther away from this, depending on the direction of movement, as well as curves that wind around the surface of a cylinder with (constant) slope (“helix”).

If the air conduction device 120 is designed as tubes with constant more or less round cross section, then the wall 34 preferably has one or more spirals that extend along the air conduction device 120 and whose longitudinal axis is more or less identical to the longitudinal axis of the air conduction device 120, and whose diameter also roughly coincides with the diameter of the air conduction device 120.

If the air conduction device 120 is designed as a flattened sheetlike hose, it preferably has several spirals whose longitudinal axes are arranged alongside each other in the plane of the air conduction device 120. Preferably, the air conduction device 120 is separated by an air layer at least partly from other parts of the seat back, in order to thermally insulate it.

The air conduction device 120 has a plurality of flow branches 121a, b, among which an air flow delivered by an air delivery device 122 is distributed, or by which the air is suctioned off by means of a shared air delivery device 122 from a plurality of ventilated/climate controlled zones 50, 52. These flow branches preferably run on the A-side of the cushion 400 parallel to the recesses 27 of the foam rubber core. They can be arranged in their own recesses. Preferably, each ventilated/climate controlled zone 50, 52 of the cushion 400 is provided with its own recess 29, through which the air conduction device 120 or one of its flow branches is led from the bottom of the cushion (B-side) to the top of the cushion (A-side).

For this, a slotlike opening is provided in the foam rubber for each branch 121a, b. At the B-side, all flow branches 121a, b emerge into a body 121x made from the same material as the branches 121a, b. Body 121x and flow branches 121a, b are made as one component in a single work step. On the body 121x there is a fastening device for the air delivery device, e. g., the snap connector of the radial fan. The larger the base surface of the body 121x, the better the air distribution to the individual branches 121a, b. The distances of the exits of the flow branches 121a, b from the fan connection point should be roughly the same length, so that the distribution of the air flow among all branches 121a, b and, thus, all cushion surfaces is the same. Preferably, all branches 121a, b are arranged on one side of the rectangular body 121x. This arrangement is chosen when only the central areas of a seat surface need to be ventilated. Optionally, additional branches 121a, b can also be provided to supply other regions of the cushion, such as two additional branches to ventilate the side cheeks. A heating element 110′ can be connected to the flow branches 121a, b. For this, individual heating fields (flexible surface heating element) can be laminated onto the branch surface. The electrical feed wires are led along the branches 121a, b to the body 121x. The cable exit for the seat heating can also be situated in the region of the fan. The contacting of the heating wires can occur at the point where the branch emerges in the body, or a meandering heating circuit can cover all branches 121a, b with a heating.

1. A Climate control arrangement for an interior appointment object of a vehicle with at least one air delivery device and at least one air distributing device, characterized in that the air distributing device has at least two flow branches.

2-10. (canceled)

11. A seat with a climate control arrangement comprising:
a seat cushion, seat back, or both with at least two ventilated or climate controlled zones respectfully;
at least one dedicated flow branch of the climate control arrangement disposed in each of the at least two ventilated or climate controlled zones, wherein the flow branches are connected to a shared air delivery device, wherein the flow branches include a plurality of air outlets and the shared air delivery device has at least one air inlet; and
a seat cover disposed over the climate control arrangement.

12. The seat according to claim 11, wherein the seat cushion and the seat back both have an A-side surface facing an occupant and an opposing B-side surface, further wherein the shared air delivery device is arranged at least partially under the B-side surface and the at least one dedicated flow branch is arranged on the A-side surface.

13. The seat according to claim 12, wherein the climate control arrangement includes at least one heating element.

14. The seat according to claim 12, wherein the flow branches have individual heating fields.

15. The seat according to claim 12, wherein the flow branch includes an air impermeable wall and air permeable flow channel.

16. the seat according to claim 15, wherein the air permeable flow channel includes buttressing material and the air impermeable wall includes portions of stretchable material.
